(19) United States
(12) Patent Application Publication
(10) Pub. No.: US 2002/0170645 A1
(43) Pub. Date: Nov. 21, 2002

(54) Vehicle tire with light reflective members

(76) Inventors: Patrick J. Norwood, New Orleans, LA (US); Roy L. Williams, Jefferson, LA (US)

Correspondence Address: THOMAS S. KEATY, KEATY PROFESSIONAL LAW CORP., 2140 WORLD TRADE CENTER, NO. 2 CANAL STREET, NEW ORLEANS, LA, 70130, US

(21) Appl. No.: 09/860,138

(22) Filed: May 17, 2001

(51) Int. Cl. B29D 30/66

(52) U.S. Cl. 152/209.16; 156/114; 152/209.25

(57) ABSTRACT

An assembly for manufacturing vehicle tires with light-reflective members has one or more plug inserts positionable inside a tire mold before vulcanization of the tire. The plug inserts each have a cutout in the back thereof corresponding to the portion of the tread design where reflective members are to be positioned. An elongated reflective member is placed in each of the plug inserts. When a vehicle tire is placed in the tire mold and treated under pressure, the tire expands conforming to the tire mold, while fusing the light reflective member into the tire body.

### BACKGROUND OF THE INVENTION

This invention relates to tires, and, more particularly, to vehicle tires having reflective elements embedded therein.

The use of reflective elements on tires has been known for some time. The reflective elements are placed on the tires for both decorative and safety reasons. For instance, bicycles, which are normally not equipped with taillights, benefit from incorporation of a reflective element into the sidewall of the tire, so that pedestrians and drivers alike can see a rotating tire during nighttime.

The pattern of the reflective elements differs, depending on the manufacturer's design, some of such designs being highly decorative. Designers have also approached the matter of providing the reflective elements on pneumatic tires for safety reasons. The rotating tire, in addition to the taillights of an automobile, provides better visibility and identification of the speed of a moving vehicle.

One of the methods of providing tires with reflective elements is disclosed in U.S. Pat. No. 3,496,782 issued on Mar. 30, 1976 to Petrasek, et al. In that patent, the reflective elements are located on the periphery of the tire to reflect light in a direction perpendicular to the axis of rotation of the tire. The reflective elements are located on the shoulder area of the tire 180 degrees from the corresponding reflective element in the opposite shoulder of the tire. The two elements each define a peak of a sine wave that has a wavelength equal to the circumference of the tire. When the tire is rotated, the tire generates an optical response of a sine wave that differs depending on the frequency of rotation. The reflective elements are located in the grooves of the road-engaging tread surface. The reflective chips are about 1 inch long and are arranged in a special pattern.

While this careful position of the reflective chips in the grooves may prove satisfactory on some occasions, there remains a need for a method of incorporating reflective elements into a vehicle tire such that the reflective elements are securely fused into the tire body.

### SUMMARY OF THE INVENTION

It is, therefore, an object of the present invention to provide a vehicle tire with light reflective members incorporated into the tread of the tire both during original manufacturing, and/or after market tires of all sizes.

Another object of the present invention is to provide a method of incorporating reflective elements into the tire structure during vulcanization of the tire.

It is a further object of the present invention to provide an assembly for manufacturing vehicle tires with reflective elements molded therein.

These and other objects of the present invention are achieved through a provision of an assembly for making vehicle tires with light-reflective members. The assembly has one or more plug inserts positionable inside a tire mold before vulcanization of the tire. The plug inserts each have a cutout in the back thereof corresponding to the portion of the tread design where reflective members are to be positioned. Each plug insert has a peripheral lip to create a distance between a reflective member and the outermost surface of the raised tread design on the tire to avoid contact of the reflective member with the road when the tire is in use.

An elongated reflective member is placed in each of the plug inserts. When a vehicle tire is placed in the tire mold and treated under pressure, the tire expands conforming to the tire mold, while fusing the light reflective member onto the undertread of the tire body.

The vehicle tire manufactured according to the method of the present invention has a plurality of reflective members fused into its body. The reflective members may be placed in parallel pairs and spaced about the circumference of the tire body. When the tire rotates, the reflective members increase safety by reflecting light from headlights and other light sources.

### BRIEF DESCRIPTION OF THE DRAWINGS

Reference will be made to the drawings, wherein like parts are designated by like numerals and wherein FIG. 1 is a front view of the vehicle tire mold with a tread design and a plug insert positioned therein.

FIG. 2 is a side view showing position of the reflective elements in relation to the raised tread of the tire.

FIG. 3 is a schematic view of the method of incorporating the reflective elements into the tire body.

FIG. 4 is a front view of the tread portion of the tire with the reflective elements incorporated therein; and

FIG. 5 is a side view showing position of four reflective members in the tire body.

### DETAIL DESCRIPTION OF THE PREFERRED EMBODIMENT

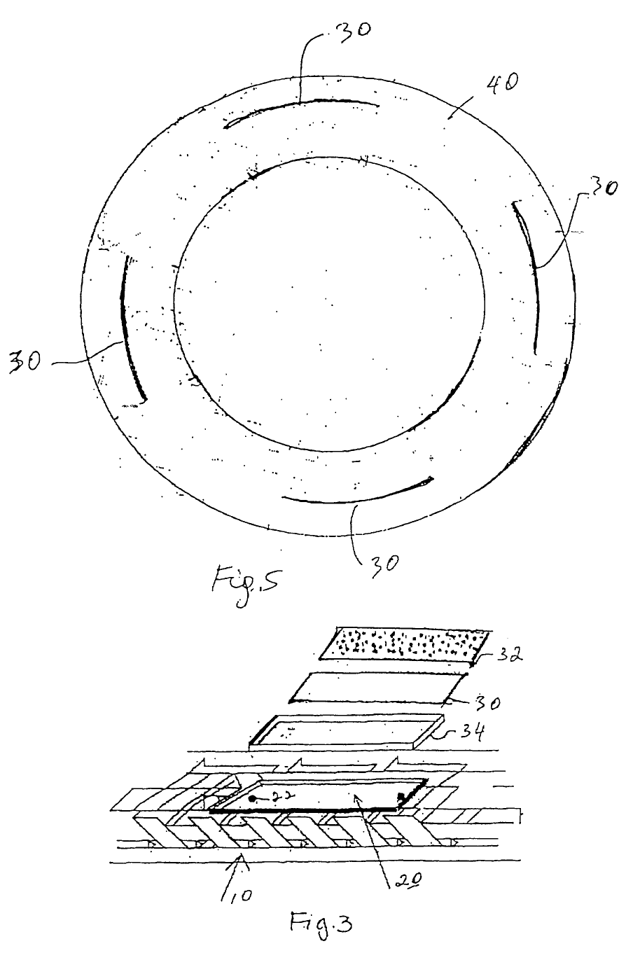

Turning now to the drawings in more detail, FIG. 3, numeral 10 designates a tire mold, for instance a radial tire mold that is used in manufacturing of conventional radial tires using vulcanization process, however, the same basic concept could be employed on bias construction molding equipment. Conventionally, radial tires are molded in a tire mold that is comprised of various identical segments (number of segments vary with the size of the tire desired) arranged to form a ring. Each segment has a tread pattern indented thereon to form a tread design on the finished tire.

The tread design shown in FIG. 1 has four tread patterns, arranged in a zigzag pattern and divided in pairs facing each other. The tread design are identified by numerals 12, 14, 16, and 18 in FIG. 1. The tread design is created during a vulcanization process. An unfinished tire is placed into the mold, then all segments regarding radial construction are clamped together and pressure is applied to the interior of the tire to push the rubber material outwardly into the crevices defined by the mold.

During the process of manufacturing the tire with reflective members in accordance with the present invention, the mold of the tire is not altered in any way. Instead, an plug insert 20 is positioned inside the mold and is secured therein by a plurality of stabilizing pins 22 in the mold segments. A peripheral lip 24 is formed about the periphery of the plug insert 20, the lip being relatively small, about 1/32-1/64 inch deep (approximately one-half the thickness of the reflective material to be inserted). It is envisioned, that in some tread design applications that the stabilizing pins 22 may not be necessary and only the lip 24 will help secure the plug inserts within the mold 10 by snapping into the mold body.

Each plug insert 20 has an backside surface that is carved with a tread design that matches the tread design of tire mold segment. The inner surface 26 of the plug insert 20 is relatively smooth, with no design embossed or engraved thereon. An elongated strip of reflective material 30 is fitted into the plug insert 20. The reflective material has a pre-made back material (usually cushion gum bonding agent).

Some reflective strips 30 may have an outer protective layer 34 (FIG. 3) that will be inserted between the plug insert 20 and the reflective strip 30. The protective layer 34 may be a polyurethane layer or other similar substance to protect the reflective tape 30 against the elements when the tire is exposed to the road conditions.

Next, an unfinished tire is placed in the mold and the segments of the mold are clamped together, enclosing the tire and the reflective member 30 inside the tire mold 10. When an expanding force is applied to the interior of the tire, the tire expands, causing the tire material to mold into the mold pattern, while fusing the reflective members 30 into the tire body undertread.

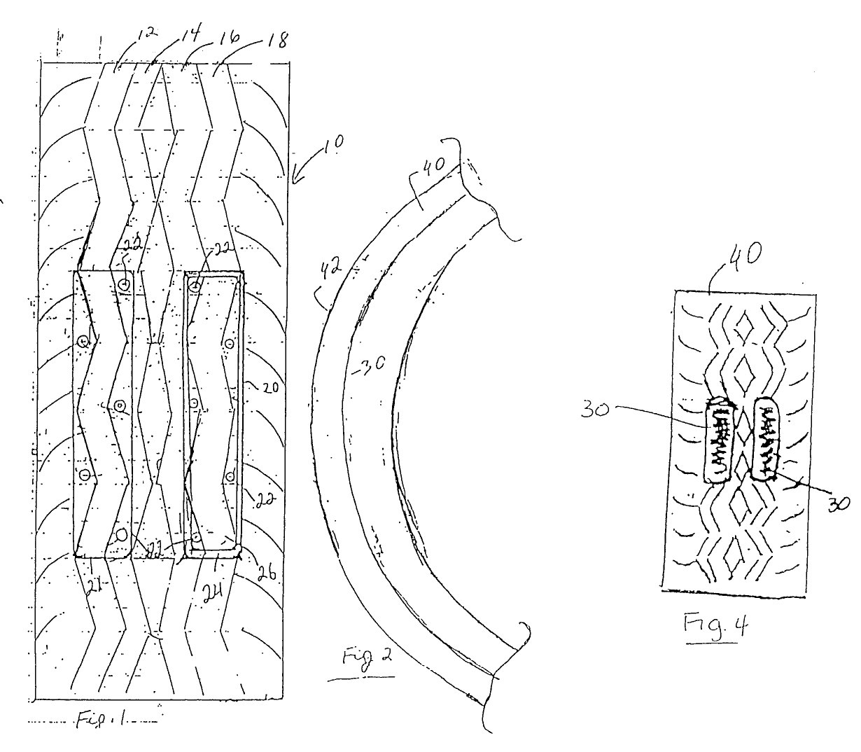

In the preferred embodiment of the present invention, a tire 40 (FIG. 2) has reflective elements 30 fitted under the most outwardly portion 42 of the tire. Also in the preferred embodiment, the tire 40 has two reflective strips 30 mounted in parallel in one particular segment of the tire (FIG. 4). As shown in FIG. 1, two plug inserts 20 and 21 are positioned side by side in the tire mold 10, the plug inserts helping secure the reflective members 30 during the pressure treatment process.

It is preferred that several pair of reflective members 30 be incorporated into each tire. For instance, FIG. 5 shows four such pair equidistantly spaced from each other about the circumference of the tire 40. It is preferred that the reflective elements 30 are not formed as one continues strip, but rather be separated by spaces without the reflective elements. In this manner, when the tire is in use, the elongated reflective strips will form an alternating pattern of dark-light portions that is easily visible from a following vehicle. The length of the reflective material could determine the speed of the vehicle from a dotted pattern to a continuous stripe. As the speed of the vehicle increases, the dotted pattern decreases and a visual continuous stripe is formed.

The plug inserts 20 and 21 are detachably positionable inside a standard tire mold 10, allowing the manufacturer to use the same mold for making tires with or without reflective elements. If the stabilizing elements 22 are omitted, the plug inserts 20, 21 can be simply snapped on and off inside the mold 10 without affecting the strength of the tire and the safety of its operations.

As shown in FIG. 2, a reflective strip 30 along with the cushion gum back, bonding agent 32 is positioned (on the undertread surface) inwardly from the most outwardly raised tread surface 42. In this manner, the reflective element 30 is not exposed to the road surface, but is visible in the groove between the raised tread portions when light from the headlights of the following car and oncoming cars or from streetlights reflects off the surface of the strips 30.

Since the reflective strips 30 do not touch the ground during normal tire operation, they will serve for as long as the tire is safe for the public roads. Of course, when the raised surface 42 of the tire 40 wears out, the tire is discarded with reflective inserts 30 embedded therein.

The insert plugs 20 can be made from a number of materials capable of withstanding high temperatures and pressure used in the molding of a tire. For instance, it is envisioned that aluminum, fiberglass, cast iron, titanium, stainless steel, and other similar materials are suitable for manufacturing of the insert plugs 20. The plug inserts 20 can vary in size and shape, depending on the tread design selected by the tire manufacturer. The insert plug 20 can be a part of the original matrix design

It is required that the insert plugs 20 precisely conform to the shape of the curved segment forming part of the tire mold 10 in order to remain intact during the molding process. If the plug inserts 20 are precisely manufactured, there may be no need for the stabilizing pins or setscrews 22. When vulcanization of the tire is complete, the reflective members 30 will remain fused to the undertread of the tire until the tire is usefulness is expired.

The method of manufacturing tires with reflective tapes may be used by manufacturers of radial tires, as well as manufacturers using biased ply construction methods. The original matrix design of the tire tread is not destroyed or in any way altered by the provision of the reflective inserts incorporated into the tire body.

Many changes and modifications can be made in the design and method of the present invention without departing from the spirit thereof. We, therefore, pray that our rights to the present invention be limited only by the scope of the appended claims.

We claim:

1. A vehicle tire comprising a tire body with a raised tread portion and a plurality of light reflective elements spaced about an outer circumference of the tire, said reflective elements being located inwardly from an outermost surface of the raised tread portion and are fused into the tire body.

2. The vehicle tire of claim 1, wherein said reflective elements are vulcanized into the tire body during molding of the tire.

3. The vehicle tire of claim 1, wherein each of said reflective elements comprises a strip of reflective material capable of reflecting light directed to an outer surface of the reflective strip and a cushioned back layer securely connected to an inner surface of the reflective strip.

4. The vehicle tire of claim 1, further comprising a plug insert positioned in contact with the tire body outwardly from each of said reflective elements during molding of the tire body, said plug insert facilitating stable positioning of each said reflective elements in relation to said tire body during fusing of the reflective elements into the tire body.

5. The vehicle tire of claim 1, wherein said reflective elements are fused in pairs into said tire body, said pairs spaced equidistantly about the outer circumference of the tire body.

6. A method of manufacturing a vehicle tire with light reflective elements, comprising the steps of:
providing a tire mold having a relief corresponding to a desired raised tread design;
providing a plug insert having a cutout portion corresponding to a part of the tread design and positioning the plug insert into the tire mold;
providing a light reflective member and positioning said strip into the plug insert;
providing a tire body suitable for molding by a vulcanization process;
positioning said tire body into the tire mold inwardly from said reflective member;
treating said tire body under heat and pressure to cause molding of the tire body and fusing of the reflective member into the tire body.

7. The method of claim 6, wherein said plug insert snaps into the tire mold inwardly from the outermost surface of the tread design mold.

8. The method of claim 7, wherein said plug insert is provided with a peripheral lip to create a distance between the outermost surface of the tread mold and said reflective member.

9. The method of claim 6, wherein said reflective member comprises an elongated strip of light reflective material carrying a cushion back on an inner surface thereof.

10. The method of claim 6, further comprising a step of providing a plurality of said reflective members and positioning said members in pairs in a spaced relationship about the circumference of said tire body.

11. The method of claim 6, wherein said plug insert is detachably positioned in said tire mold.

12. The method of claim 6, wherein said plug insert is detachably secured in said tire mold by a plurality of stabilizing members.

13. The method of claim 6, wherein said reflective member is fused into the tire body in a position to avoid contact of said reflective member with a road surface when the vehicle tire is in use.

14. An assembly for making a vehicle tire with reflective elements, said assembly comprising:
an insert plug for positioning inside a tire mold, said plug insert being provided with a cutout corresponding to a tread design formed in the tire mold; and
a reflective member adapted for positioning in said insert plug.

15. The assembly of claim 14, further comprising a plurality of stabilizing members for securing position of said plug insert in the tire mold.

16. The assembly of claim 14, wherein said reflective member comprises an elongated strip having a light-reflective outer surface and a cushion gum bonding material back.

17. The assembly of claim 14, wherein said plug insert is provided with a peripheral lip for spacing said reflective member from an outermost raised tread portion of the vehicle tire.
